(19) United States
(12) Patent Application Publication
(10) Pub. No.: US 2006/0059672 A1
(43) Pub. Date: Mar. 23, 2006

(54) Handheld panel spacer insertion device

(76) Inventor: Steven Trent Hoshor, Ames, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/233,698

(22) Filed: Sep. 23, 2005

Related U.S. Application Data
(60) Provisional application No. 60/522,385, filed on Sep. 23, 2004.

(51) Int. Cl. B23P 19/04

(52) U.S. Cl. 29/252

(57) ABSTRACT

A spacer insertion device including a body, a container secured to the body for storing a spacer, a piston secured to the body, a trigger secured to the body, the trigger operatively linked to operate the piston, and a chamber adapted to receive the spacer from the container and to place the spacer in position for the piston to act on the spacer and force it out of the device. The spacer insertion device may include an additional disruptive means associated with the container. The spacer insertion device of the present invention may also include a plurality of pistons that may be pneumatically operated. The spacer insertion device may also include a restraining member to temporarily block spacers and prevent unnecessary discharge of the spacer.

### PRIORITY STATEMENT

This application claims priority to U.S. Provisional Patent Application No. 60/522,385, filed Sep. 23, 2004, herein incorporated by reference in its entirety.

### FIELD OF THE INVENTION

The present invention relates generally to wood working equipment and more specifically to a device for inserting spacers into a variety of products including cabinet doors, panel doors, and other panel products.

### BACKGROUND OF THE INVENTION

Spacers or space balls are commonly used in wood panel products such as doors and cabinets. Spacers are typically round rubber balls. These spacers are usually placed in a groove in the frame work surrounding the panels before the panels are inserted. Using spacers in between the frame work and the panels allows the panels to expand and contract or move slightly without appearing loose.

Prior to the present invention, spacers were inserted by a number of methods. Initially inserted by hand, large scale cabinet makers have begun to insert spacers using complex pneumatic devices. These devices are typically very expensive. They use a remote hopper or container to hold the supply of spacers. These hoppers are vibrated to force a spacer to fall into line or into the queue.

Once in the queue, the spacers are led down a supply line to an insertion gun. The air line is pressurized so that the end user can simply pull a trigger and release a burst of air and a corresponding spacer. This set up has several disadvantages. For example, the remote hopper requires long supply lines which must be pressurized. It also minimizes the chance that the user will be aware of the supply status of the spacers.

The constantly pressurized supply line also requires some means by which to block the pressure to prevent a stream of spacers from fly out. Because of the required pressurization, additional safety devices are also necessary to prevent inadvertent firing of the spacers from the device. It is therefore desirable to provide a device for inserting spacers that is inexpensive and allows the user to monitor the supply of spacers and minimizes the chances for accidental spacer release.

Other devices are typically stationary devices which allow a user to approach the machine, insert the frame portion and align the frame's groove with the machine's insertion mechanism. This insertion mechanism can be either pneumatic or piston operated. Unfortunately, the size of these machines requires the user to move the part off of an assembly line and onto the machine. It is therefore desirable to have a spacer insertion device that is portable and easy to use.

It is a goal of the present invention to provide a spacer insertion device that solves these and other problems.

### FEATURES OF THE INVENTION

A general feature of the present invention is the provision of a spacer insertion device which overcomes the problems found in the prior art.

A further feature of the present invention is the provision of a spacer insertion device that is inexpensive to own and operate.

Another feature of the present invention is the provision of a spacer insertion device that is safe to use.

A still further feature of the present invention is the provision of a spacer insertion device that allows the user to monitor the supply of spacers at all times.

Another feature of the present invention is the provision of a spacer insertion device that is portable.

A further feature of the present invention is the provision of a spacer insertion device that is easy to use.

These, as well as other features and advantages of the present invention will become apparent from the following specification and claims.

### SUMMARY OF THE INVENTION

The present invention generally comprises a spacer insertion device including a body, a container secured to the body for storing a spacer, a piston or other insertion means secured to the body, a trigger or handle secured to the body and operatively linked to operate the piston or push rod and a chamber adapted to receive the spacer from the container and to place the spacer in position for the piston to push the spacer out of the device. The piston or piston rod can be pneumatically operated, mechanically operated or spring loaded. The spacer insertion device also can include a restraining member to prevent accidental release of a spacer. Another piston, agitator, or other disruptive means can also be included to act on or agitate the spacers in the container.

### BRIEF DESCRIPTION OF THE DRAWINGS

FIG. 1 is a perspective view of one embodiment of the present invention.

FIG. 2 is a front view of one embodiment of the present invention.

FIG. 3 is a top view of one embodiment of the present invention.

FIG. 4 is a cross-sectional view of one embodiment of the present invention taken along line 4-4 of FIG. 2.

### DETAILED DESCRIPTION OF THE PREFERRED EMBODIMENT

The present invention will be described as it applies to its preferred embodiment. It is not intended that the present invention be limited to the described embodiment. It is intended that the invention cover all modifications and alternatives which may be included within the spirit and scope of the invention.

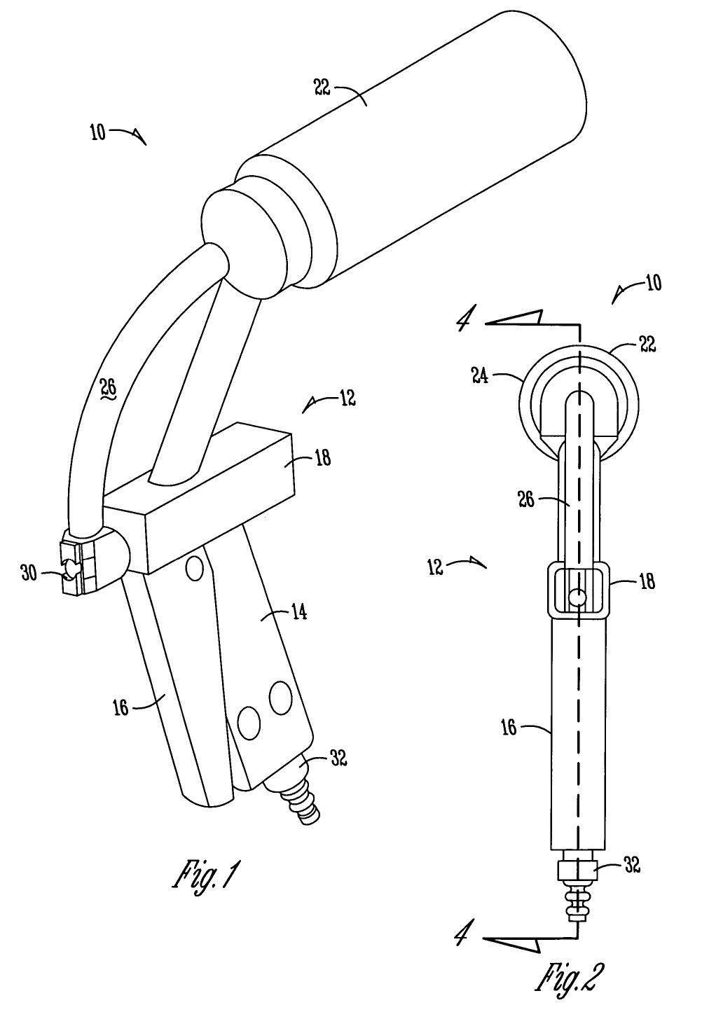

Now, referring to the drawings, FIGS. 1 and 2 illustrate the spacer insertion device 10 of the present invention. The spacer insertion device 10 includes a body 12 having a handle 14 that includes a trigger 16. The trigger 16 may be in the form of a handle, lever, button or other mechanism that operates the device 10. The trigger 16, handle 14 and body 12 are typically made from aluminum, but can be made from any suitably strong material including steel, plastic, fiberglass, etc.

Attached to the handle 14 is a chamber 18. The chamber 18 is where the spacers 19 will be just prior to insertion. A piston 20 or other insertion means is secured within the chamber 18. Preferably, the piston 20 is pneumatically operated by air provided either from an air hose or a compressed air cylinder. Air from a compressed air hose may be supplied to a quick connect air connection 32 which is operatively connected to the piston 20 and the disruptive means 28. Alternatively, the piston 20 may use an air cartridge such as a CO₂ cartridge or may be a spring loaded piston.

If a trigger 14 is not desired, the handle 14 may be mounted to slide back and forth along the chamber 18. In this arrangement (not shown), the handle 14 is operatively connected to the piston 20, a piston rod, a slidable shaft, or other insertion means to insert a spacer 19 into a groove on a piece of material.

Secured to the body 12 is a container or hopper 22. The container or hopper 22 generally includes a reservoir 24 and a supply line 26 or guiding means. The supply line 26 receives spacers 19 in a single file line from the reservoir 24. The spacers 19 in the reservoir 24 are preferably agitated by another piston 28, a stirring rod, a vibration pad, or another disruptive means.

Secured to the chamber 18 opposite the piston 20 is a restraining member or inhibiting means 30 as is shown in FIG. 4. The inhibiting means 30 may be a piece of metal such as a set screw or may be incorporated directly into the body 12 or the chamber 18 as shown. Preferably, the inhibiting means 20 is located within a positioning section of the chamber 18. The positioning section of the chamber 18 is generally no wider than a standard groove into which a spacer 19 is placed. A portion of the positioning section, the inhibiting means 30, is preferably crimped to narrow the passageway through which the spacers 19 travel, thus preventing them from leaving the chamber unintentionally.

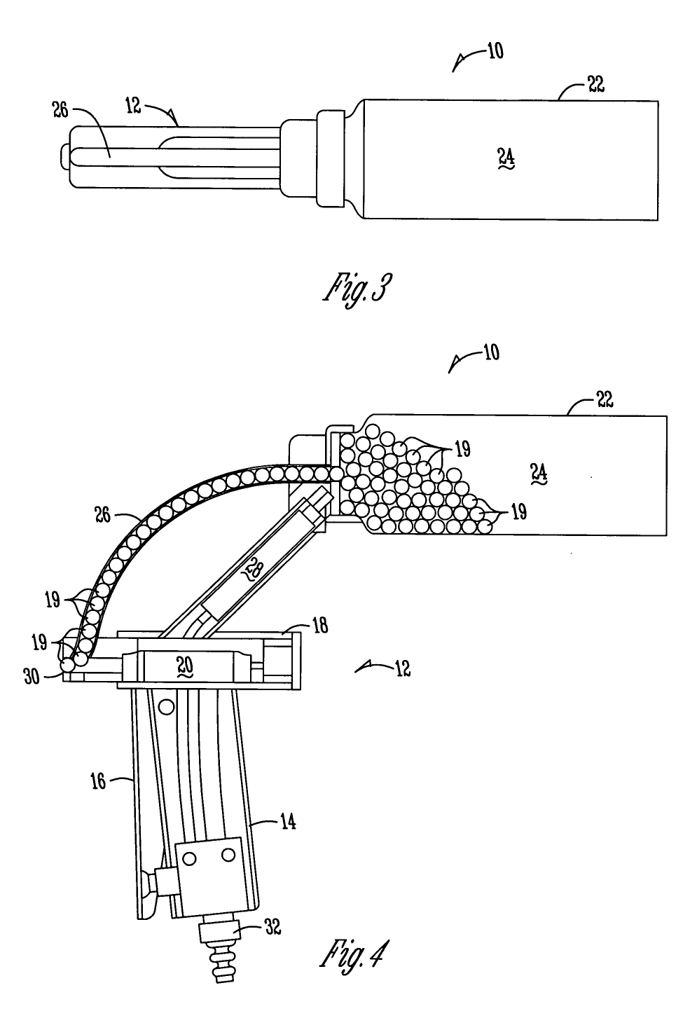

As is shown in FIG. 3, the spacers are initially dumped or added to the container 22 which may be made of plastic, metal, glass or any other material which is capable of supporting a bulk of spacers 19. From the container 22, the spacers 19 are agitated to fall, preferably under the force of gravity alone, into the supply line 26 which is preferably a piece of plastic tubing. In the supply line 26, the spacers 19 line up in a single file row and await their turn in the chamber 18. Once in the chamber 18, the spacer 19 is restrained by the inhibiting means 30 until such time as the user desires a spacer 19 be inserted.

When the user determines it is time to insert a spacer 19, the user grabs the device 10, inserts the inhibiting means 30 into a groove or desired location and squeezes the trigger 18. Squeezing the trigger 18 causes the piston 20 to operate, extending the piston rod into the chamber 18 and pushing the spacer 19 past the inhibiting means 30, thus inserting the spacer 19 into the desired location.

A general description of the present invention as well as a preferred embodiment of the present invention has been set forth above. Those skilled in the art to which the present invention pertains will recognize and be able to practice additional variations in the methods and systems described which fall within the teachings of this invention. Accordingly, all such modifications and additions are deemed to be within the scope of the invention which is to be limited only by the claims appended hereto.

What is claimed is:

1. A spacer insertion device comprising:
a body;
a container secured to the body for storing a spacer;
a piston secured to the body;
a trigger secured to the body, the trigger operatively linked to operate the piston; and
a chamber adapted to receive the spacer from the hopper and to place the spacer in position for the piston to push the spacer out of the device.

2. The spacer insertion device of claim 1 wherein the piston is a pneumatically operated.

3. The spacer insertion device of claim 1 further comprising a restraining member secured to the chamber opposite the piston.

4. The spacer insertion device of claim 1 further comprising a piston secured to the container to disrupt the spacers contained therein.

5. The spacer insertion device of claim 1 wherein the body includes a handle.

6. A device for inserting spacers comprising:
a body having a handle and a chamber;
a trigger secured to the body; and
a container secured to the body, the container including a reservoir and a supply line.
